(19) United States
(12) Patent Application Publication
(10) Pub. No.: US 2014/0111080 A1
(43) Pub. Date: Apr. 24, 2014

(54) METHOD FOR PRODUCING A WINDING FOR PRODUCING ELECTRODES FOR DISCHARGE LAMPS, WINDING PROPERTIES IN ELECTRODES FOR DISCHARGE LAMPS AND METHOD FOR PRODUCING AN ELECTRODE FOR DISCHARGE LAMPS

(71) Applicants: Jarmila Bilikova, Siroka Niva (CZ); Gerald Haemmer, Koenigsbrunn (DE); Achim Hilscher, Friedberg (DE); Pavel Knoll, Krnov (CZ); Alena Michalikova, Kravare (CZ); Petr Rumpertesz, Havirov Mesto (CZ); Josef Schlecht, Poettmes (DE); Ales Vojkuvka, Krnov (CZ); Klaus Weingaertner, Augsburg (DE)

(72) Inventors: Jarmila Bilikova, Siroka Niva (CZ); Gerald Haemmer, Koenigsbrunn (DE); Achim Hilscher, Friedberg (DE); Pavel Knoll, Krnov (CZ); Alena Michalikova, Kravare (CZ); Petr Rumpertesz, Havirov Mesto (CZ); Josef Schlecht, Poettmes (DE); Ales Vojkuvka, Krnov (CZ); Klaus Weingaertner, Augsburg (DE)

(73) Assignee: OSRAM GMBH, Muenchen (DE)

(21) Appl. No.: 14/009,140

(22) PCT Filed: Mar. 13, 2012
(86) PCT No.: PCT/EP12/54356

§ 371 Date: Dec. 10, 2013

(30) Foreign Application Priority Data
Apr. 1, 2011 (DE) 10 2011 006 620.9

(51) Int. Cl. H01J 9/18; H01J 1/50

(52) U.S. Cl. CPC H01J 9/18; H01J 1/50
USPC 313/155; 445/50

(57) ABSTRACT

A method for producing a primary winding for producing an electrode for discharge lamps includes: producing a primary winding, wherein producing the primary winding comprises: providing a primary core wire, which has a longitudinal axis and consists of an electrically conductive material, winding a cladding wire around the primary core wire along the longitudinal axis of the primary core wire, with the result that the cladding wire forms a primary core wire cladding surrounding the primary core wire, and winding a wrapping wire around the primary core wire cladding at a radial distance from the primary core wire along the longitudinal axis of the primary core wire.

### RELATED APPLICATIONS

The present application is a national stage entry according to 35 U.S.C. §371 of PCT application No.: PCT/EP2012/054356 filed on Mar. 13, 2012, which claims priority from German application No.: 10 2011 006 620.9 filed on April 1, 2011.

### Technical Field

Various embodiments relate to methods for producing a winding for producing an electrode for discharge lamps, windings for producing an electrode for discharge lamps and methods for producing an electrode for discharge lamps.

### BACKGROUND

In discharge lamps as described, for example, in US 2004/0070324 A2, the aim is to increase the emitter quantity on the electrode filament in order to thus achieve a longer life or lighting duration of the discharge lamp. For this purpose, US 2004/0070324 A2 proposes providing a double-filament or triple-filament wire structure, by which the emitter material which is, for example, a (Ba, Ca, Sr) 0 material (applied as (Ba, Ca, Sr) CO₃ material) is held. Owing to the increase in volume achieved by means of the filament wire structure, a greater quantity of emitter material can be held between and on the wires of the filament wire structure.

In order in the process to achieve a relatively large radial distance of a wrapping wire from a primary core wire even in the primary filament structure, an additional, lost core wire is provided which runs parallel to the primary core wire in order thus to achieve overall a core with a total diameter including the diameters of the primary core wire and the lost core wire.

During winding of such a primary filament structure around a secondary core wire, however, it is generally not possible to achieve a uniform radial distance of the primary core wire from the secondary core wire, for which reason the electrical resistance of the filament structure is uneven in the longitudinal direction of said filament structure. In order to keep the resistance distribution within a permitted tolerance framework in the longitudinal direction of the filament structure, therefore, the maximum diameter of the lost core wire of the primary filament structure therefore cannot be selected to be too great.

Various embodiments provide methods for producing a winding for producing an electrode for discharge lamps and windings for producing an electrode for discharge lamps in order to overcome the problems encountered in the prior art.

### SUMMARY

Various embodiments provide a method for producing a primary winding for producing an electrode for discharge lamps, includes: providing a primary core wire, which has a longitudinal axis and consists of an electrically conductive material, winding a cladding wire around the primary core wire along the longitudinal axis of the primary core wire, with the result that the cladding wire forms a primary core wire cladding surrounding the primary core wire, and winding a wrapping wire, which consists of an electrically conductive material, for example, around the primary core wire cladding at a radial distance from the primary core wire along the longitudinal axis of the primary core wire.

The primary core wire and the wrapping wire consist of a material with good thermal resistance, such as tungsten (W), for example. The cladding wire, which, as will be explained later, is a lost cladding wire, likewise consists of a material with good thermal resistance but which is less resistant to solvents or corrosive agents, for example acids, than the material of the primary core wire and the wrapping wire, such as molybdenum (Mo), for example. The lost cladding wire can also consist of iron (Fe). The good thermal resistance of the primary core wire, the wrapping wire and the cladding wire makes it possible, once the primary winding for its part, as will be explained below, for example, is wound around a further core wire in the longitudinal direction of the primary core wire, to reduce the material stresses which may thus be produced in the primary winding via heat treatment, for example annealing. The lower resistance of the material of the cladding wire to corrosive agents makes it possible to remove this cladding wire from the primary core wire and the wrapping wire again, for example via dissolving in a solvent/corrosive agent, for example in an acid bath, without the primary core wire and the wrapping wire being damaged thereby. A suitable acid for the acid bath is, for example, an acid mixture such as the acid described in DE2933430C2, for example, which contains from 30 to 60% by weight of nitric acid and from 20 to 50% by weight, for example 28 to 42% by weight, of sulfuric acid and water as the remainder. The cladding wire generally thus represents a lost wire, as mentioned already above, which is used for enlarging the radial distance of the wrapping wire from the primary core wire, wherein, once the cladding wire has been removed (for example separated) from what is left of the (remaining) winding structure, which is formed by the primary core wire and the wrapping wire, a receiving area for receiving an emitter material is formed. In this case, the emitter material can be an emitter material as described, for example, in the abovementioned US 2004/0070323 A1.

By virtue of the fact that the cladding wire has been wound along the primary core wire, i.e. the cladding wire has been wound around the primary core wire for example in helical fashion, wherein the windings of the cladding wire do not overlap one another or overlap one another uniformly, for example, the primary core wire cladding thus achieved which is formed by the cladding wire has a substantially identical thickness, wherein the primary core wire is arranged (substantially) centrally. Therefore, the wrapping wire always has substantially the same radial distance from the primary core wire, even when the primary winding achieved in this way for its part is wound around a secondary core wire (for example likewise in helical fashion) since the primary core wire cannot slide relative to the cladding wire in the radial direction of said primary core wire. Thus, the diameter of the cladding wire can be selected to be very large, as a result of which a correspondingly large radial distance between the wrapping wire and the primary core wire can be achieved without the uniformity of the distribution of the electrical resistance of the final winding structure being impaired. The cladding wire is wound helically around the primary core wire with a substantially constant helix pitch, for example. In addition, the cladding wire is wound directly onto the primary core wire, for example.

The wrapping wire consists of an electrically conductive material which, as mentioned above, likewise has good thermal resistance, for example of the same material as the primary core wire and therefore of tungsten (W), for example. The wrapping wire has, for example, a smaller diameter than the primary core wire, for example a diameter that is at least 50% smaller than the primary core wire. The wrapping wire is generally wound helically, for example without any overlap of the turns or with uniform overlapping of the turns, around the primary core wire cladding. The wrapping wire is wound for example helically with a substantially constant helix pitch around the primary core wire cladding. In addition, the wrapping wire is wound, for example, directly onto the primary core wire cladding.

In accordance with one embodiment, during winding of the cladding wire, the turns of the cladding wire are arranged directly adjacent to one another, preferably adjoining one another, in the direction of the longitudinal axis of the primary core wire. As a result, a substantially closed lateral surface is achieved in order to keep the radial distance of the wrapping wire from the primary core wire the same in an improved and more precise manner.

In accordance with one embodiment, during winding of the wrapping wire, the turns of the wrapping wire are arranged at an axial distance from one another in the direction of the longitudinal axis of the primary core wire, which axial distance is greater than an axial distance between the turns of the cladding wire in the direction of the longitudinal axis of the primary core wire. The axial distance is, for example, greater than the diameter of the wrapping wire, for example more than twice as large.

In accordance with one embodiment, provision can be made for the wrapping wire to be wound around the primary core wire cladding counter to the direction of the cladding wire, i.e. for the helix pitch of the cladding wire relative to the primary core wire to have a mathematical sign which is different in comparison with the helix pitch of the wrapping wire relative to the primary core wire, wherein the absolute size of the helix pitch can be different. Thus, it is possible to ensure that the wrapping wire does not come to lie in a region in which two adjacent turns of the cladding wire adjoin one another and the radial distance from the primary core wire is smaller than a diameter of the cladding wire. Thus, a particularly uniform radial distance of the wrapping wire from the primary core wire can be provided.

In addition, the disclosure provides a method for producing a secondary winding for producing an electrode for discharge lamps, having the following steps: providing a secondary core wire which has a longitudinal axis, producing a primary winding in a manner described above, and winding the primary winding in the longitudinal direction of the primary core wire around the secondary core wire along the longitudinal axis of the secondary core wire.

The secondary core wire is generally a lost wire, corresponding to the cladding wire, with the result that, corresponding to the cladding wire, it consists of a material which is less resistive than the material of the primary core wire and the wrapping wire, for example a material which is less resistive to solvents or corrosive agents, such as acid, for example. The secondary core wire consists of the same material as the cladding wire, for example, and thus consists of molybdenum (Mo), for example.

The primary winding is generally wound helically, for example with a constant helix pitch, around the secondary core wire in the longitudinal direction of the primary core wire of said primary winding, wherein the primary winding is wound directly onto the secondary core wire, for example. The turns of the primary winding are arranged, for example, at an axial distance from one another along the longitudinal axis of the secondary core wire, which axial distance is selected, for example, in such a way that the ratio (pitch factor) of the pitch of the primary winding around the secondary core wire (this pitch corresponds to the axial length of a turn of the primary winding around the secondary core wire when measured in the longitudinal direction of the secondary core wire) is less than 2 owing to the diameter of the primary winding per se (measured transversely to the longitudinal axis of the primary core wire).

In the secondary winding manufactured in this way, heat treatment, for example annealing, can be used to reduce (wire material) stresses in the secondary winding, and then in a further step the secondary core wire and the cladding wire can be removed, for example by means of dissolving or thereby separating (for example by means of acid) the secondary core wire and the cladding wire from the (remaining) winding structure, which is formed by the primary core wire and the wrapping wire. The emitter material can be applied to or introduced into the cavities in what is left of the (remaining) winding structure of the secondary winding, as a result of which a winding structure/overall structure is achieved which can be used as an electrode for a discharge lamp. Otherwise, the discharge lamp can be constructed as described, for example, in US 2004/0070324 A1, and can thus be a low-pressure discharge lamp or else a high-pressure discharge lamp, for example.

In order to provide an even larger volume for receiving emitter material, the disclosure provides a method for producing a tertiary winding for producing an electrode for discharge lamps, having the following steps: providing a tertiary core which has a longitudinal axis, producing a secondary winding in accordance with the method as described above, and winding the secondary winding in the longitudinal direction of the secondary core wire around the tertiary core along the longitudinal axis of the tertiary core.

The tertiary core may likewise be a tertiary core wire and may consist of, for example, a material as described above for the secondary core wire (i.e. Mo or Fe, for example) and consists of, for example, the same material as the secondary core wire and/or the cladding wire. In accordance with another embodiment, the tertiary core is a component part which is not lost and may therefore be reused (for example a winding machine mandrel) consisting of, for example, hard metal such as tungsten carbide, for example. The secondary winding is, for example, wound helically in the longitudinal direction of its secondary core wire, for example with a substantially constant helix pitch, along the tertiary core around said tertiary core, for example directly onto the tertiary core, wherein the turns can be arranged so as to adjoin one another or else at an axial distance (in the longitudinal direction of the tertiary core) from one another.

Once the tertiary winding has been manufactured in the manner described above, the cladding wire, the secondary core wire and the tertiary core in the form of a (lost) tertiary core wire can be removed from the (remaining) winding structure including the primary core wire and the wrapping wire in the manner described above for the cladding wire and the secondary core wire, and then emitter material can be introduced into the cavities in this remaining winding structure or applied onto the (remaining) winding structure in order to thus provide a winding structure which can be used as such as an electrode structure/electrode in a discharge lamp. When using a reusable tertiary core, the secondary winding which is wound around the tertiary core as described above, for example, is stripped from the tertiary core in the longitudinal direction thereof in order then to remove the cladding wire and the secondary core wire in the manner explained above, i.e. to separate it using an acid bath, for example.

The diameter of the primary core wire may be constant over its entire length. The same applies to the diameter of the cladding wire, the diameter of the wrapping wire, the diameter of the secondary core wire and the diameter of the tertiary core (wire).

In accordance with the disclosure, based on the above methods the following are also provided: a primary winding for producing an electrode for discharge lamps, with a primary core wire, which has a longitudinal axis and consists of an electrically conductive material which has high thermal resistance, for example (as explained above), a cladding wire (consisting of a material as explained above, for example), which is wound around the primary core wire along the longitudinal axis of the primary core wire (for example helically as explained above), with the result that the cladding wire forms a primary core wire cladding surrounding the primary core wire, a wrapping wire (consisting of a material and a structure, for example, as explained above), which is wound around the primary core wire cladding at a radial distance from the primary core wire along the longitudinal axis of the primary core wire (for example helically as explained above), also a secondary winding for producing an electrode for discharge lamps, with a secondary core wire (consisting of a material as explained above, for example), which has a longitudinal axis, and an above-described primary winding, wherein the primary winding is wound in the longitudinal direction of the primary core wire around the secondary core wire along the longitudinal axis of the secondary core wire (for example helically as explained above), and in addition a tertiary winding for producing an electrode for discharge lamps with a tertiary core (wire) (consisting of a material as explained above, for example), which has a longitudinal axis, and a secondary winding as described above, wherein the secondary winding is wound in the longitudinal direction of the secondary core wire around the tertiary core (wire) along the longitudinal axis of the tertiary core (wire) (for example helically as explained above).

In the case of the primary winding, the turns of the cladding wire can be arranged directly adjacent to one another, preferably adjoining one another, in the direction of the longitudinal axis of the primary core wire. In addition, in the case of the primary winding, the turns of the wrapping wire can be arranged at an axial distance from one another in the direction of the longitudinal axis of the primary core wire, which axial distance is greater than an axial distance between the turns of the cladding wire in the direction of the longitudinal axis of the primary core wire. The wrapping wire may also be wound in the opposite direction to the cladding wire when viewed in the direction of the longitudinal axis of the primary core wire around the primary core wire.

The respective core wire or core (primary core wire, secondary core wire and tertiary core (wire)) and/or the cladding wire and/or the wrapping wire consist(s) of an electrically conductive material, for example. The respective core wire and/or the cladding wire and/or the wrapping wire consist of a metal material, for example.

Various embodiments also provide:

A method for producing an electrode for a discharge lamp, having the following steps: producing a secondary winding as explained above by means of the associated method as explained above, removing the secondary core wire and the cladding wire (for example in a manner as described above) so as to form corresponding emitter material receiving cavities in the remaining winding structure formed by the primary core wire and the wrapping wire, and introducing an emitter material (for example as described above) into the emitter material receiving cavities, wherein, for example, the emitter material is introduced at least or substantially exclusively into the cavities produced by the removal of the secondary wire and the cladding wire.

A method for producing an electrode for a discharge lamp, having the following steps: producing a tertiary winding as described above by means of the method explained as above, removing (for example in a manner as described above) the secondary core wire, the tertiary core (wire) and the cladding wire so as to form corresponding emitter material receiving cavities in the remaining winding structure formed by the primary core wire and the wrapping wire, and introducing an (for example as described above) emitter material into the emitter material receiving cavities.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows a schematic perspective view of a primary winding in accordance with one embodiment of the disclosure,

FIG. 2 shows a schematic perspective view of a secondary winding in accordance with one embodiment of the disclosure,

FIG. 3A shows a schematic cross-sectional view of a tertiary winding in accordance with one embodiment of the disclosure,

FIG. 3B shows a schematic perspective view of a winding structure in accordance with one embodiment of the disclosure,

FIG. 4 shows a schematic sectioned side view of a discharge lamp in accordance with one embodiment of the disclosure, and

FIG. 5 shows a schematic flowchart of a method for producing an electrode in accordance with one embodiment of the disclosure.

The same reference symbols are used in the drawing for identical or similar features.

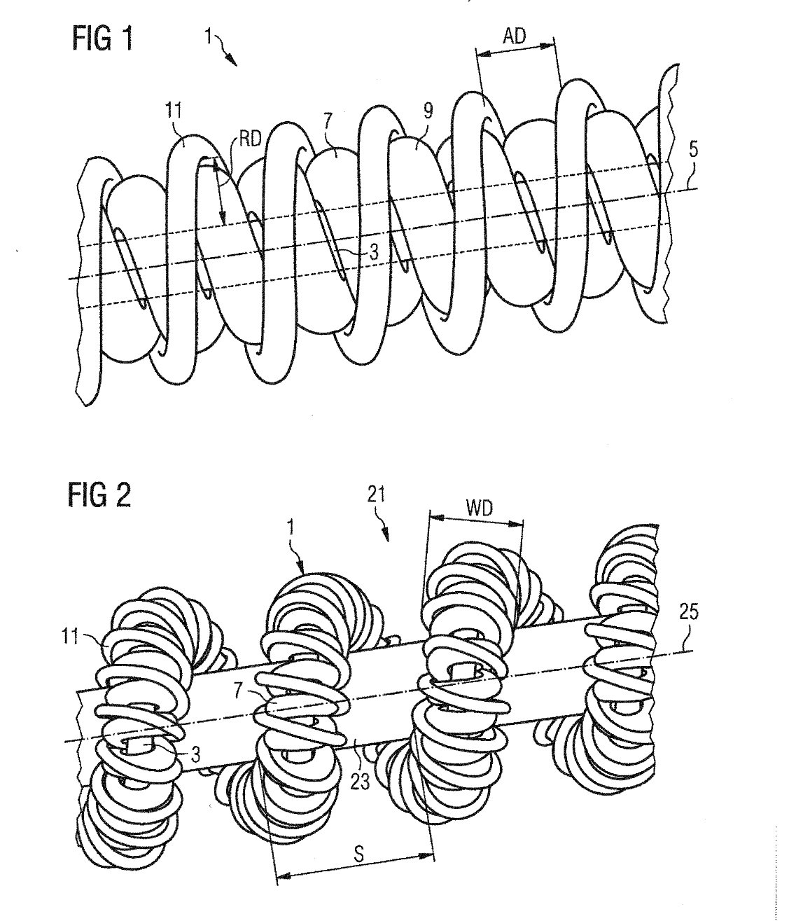

FIG. 1 shows a primary winding 1 for producing an electrode for discharge lamps in accordance with a first embodiment of the disclosure.

### DETAILED DESCRIPTION

The following detailed description refers to the accompanying drawing that show, by way of illustration, specific details and embodiments in which the disclosure may be practiced.

The primary winding 1 has: a primary core wire 3, which has a longitudinal axis 5 and consists of an electrically conductive metal material with good thermal resistance (in this case W), a cladding wire 7, which consists of an electrically conductive metal material with high thermal resistance (in this case Mo), which is different from the material of the primary core wire 3 and is less resistant to corrosive agents than the material of the primary core wire 3, and which primary core wire is wound helically with small axial distances between the turns and directly around the primary core wire 3 along the longitudinal axis 5 of the primary core wire 3, with the result that the cladding wire 7 forms a primary core wire cladding 9 surrounding the primary core wire 3, and a wrapping wire 11, which is wound helically directly around the primary core wire cladding 9 at a radial distance RD from the primary core wire 3 along the longitudinal axis 5 of the primary core wire 1 and which consists of an electrically conductive metal material with a high thermal resistance (in this case W), which is more resistant to corrosive agents than the material of the cladding wire 9.

The turns of the cladding wire 7 of the primary core wire cladding 9 are arranged axially tightly adjacent to one another when viewed in the direction of the longitudinal axis 5 of the primary core wire 3. In contrast, the turns of the wrapping wire 11 are arranged at an axial distance AD from one another when viewed in the direction of the longitudinal axis 5 of the primary core wire 3. The turns of the cladding wire 7 are wound in the direction of the longitudinal axis 5 of the primary core wire 3 in opposite directions to the turns of the wrapping wire 11 in the direction of the longitudinal axis 5 of the primary core wire 3, i.e. the helix formed by the turns of the cladding wire 7 has a pitch with a different mathematical sign than the helix formed by the turns of the wrapping wire 11.

FIG. 2 shows a perspective view of a secondary winding 21 for producing an electrode for discharge lamps, having a secondary core wire 23, which consists of an electrically conductive metal material with high thermal resistance (in this case Mo) and which has a longitudinal axis 25, and the primary winding 1 shown in FIG. 1, wherein the material of the secondary core wire 23 differs from the material of the primary core wire 3 and the wrapping wire 11 and is less resistant to corrosive agents than the material of the primary core wire 3 and the wrapping wire 11, wherein the primary winding 1 is wound helically and directly around the secondary core wire 23 along the longitudinal axis 25 of the secondary core wire 23 in the longitudinal direction (i.e. in the direction of the longitudinal axis 5) of the primary core wire 3. Thus, the wrapping wire 11 is wound primarily helically around the primary core wire 3 and secondarily (in the longitudinal direction of the primary core wire 3) helically around the secondary core wire 23. The pitch factor of the secondary winding 21, i.e. the ratio of the pitch S of the helically wound primary winding 1 along the longitudinal axis 25 of the secondary core wire 23 to the diameter WD of the primary winding 1 per se is selected to be less than 2 (S/WD<2).

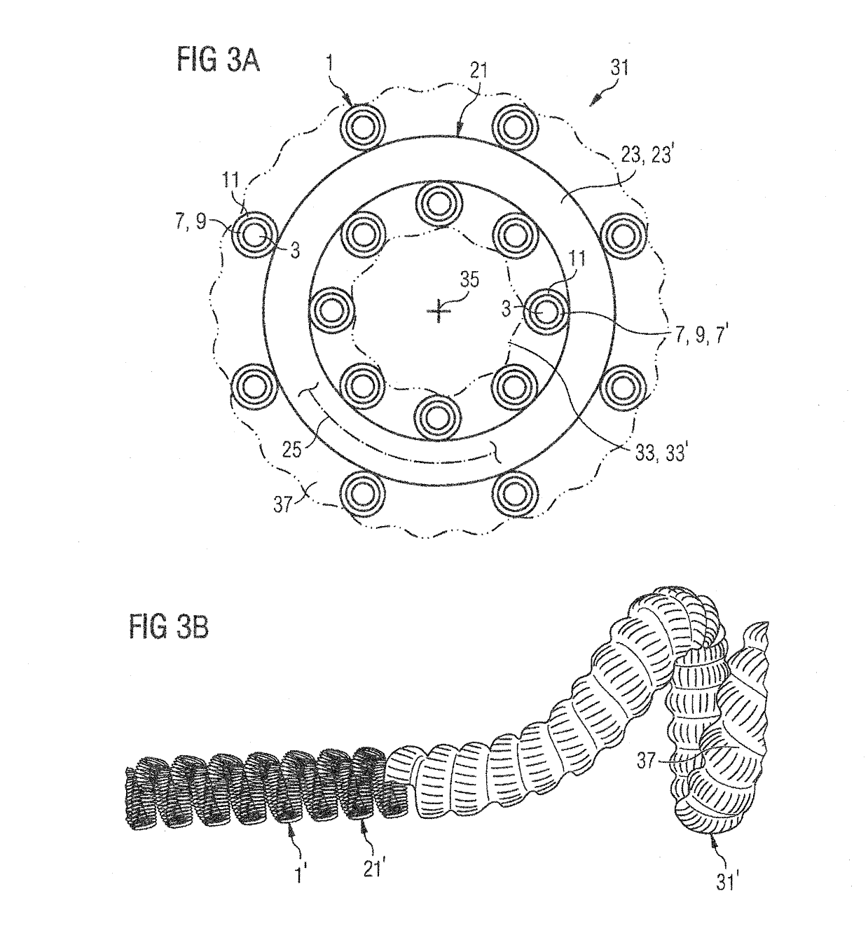

FIG. 3A shows, in cross section, a tertiary winding 31, which has been obtained by virtue of the fact that the secondary winding 21 illustrated in FIG. 2 has been wound for its part helically and directly around a tertiary core (wire) 33 in the longitudinal direction (i.e. in the direction of the longitudinal axis 25) of the secondary core wire 23, to be precise along the longitudinal axis 35 (perpendicular to the image face in FIG. 3A) of the tertiary core (wire) 33. The tertiary core (wire) 33 consists of an electrically conductive metal material with high thermal resistance (in the case of a lost tertiary core wire, for example Mo, and in the case of a reusable tertiary core (machine core or machine mandrel) for example hard metal), which is different than the material of the primary core wire 3 and the wrapping wire 11 and is less resistant to corrosive agents than the material of the primary core wire 3 and the wrapping wire 11.

In order to produce, for example, an electrode for a discharge lamp, the secondary winding 21 shown in FIG. 2 or the tertiary winding 31 constructed as in FIG. 3A, for example, is introduced into an etching solution, for example into an acid bath, in order to remove the cladding wire 7, the secondary wire 23 or the tertiary core (wire) 33 from the (remaining) winding structure, which is formed by the primary core wire 3 and the wrapping wire 11 and which is more resistant to this etching solution, by being dissolved and separated. The cavities 7′, 23′ thus produced, generally with the exception (but not restricted to this exception) of the cavity 33′ formed by the tertiary core (wire) 33 (see FIG. 3A), which cavities have a hollow configuration corresponding to the configuration of the cladding wire 7, the secondary wire 23 and possibly the tertiary core (wire) 33 of the secondary winding 23 or the tertiary winding 31, are then filled together with cavities which are otherwise already present between the primary core wire 3 and the turns of the wrapping wire 11 with an emitter material 37 (illustrated in FIG. 3A by a dot-dot-dash line), which is a (Ba, Ca, Sr) CO₃ material, for example. The mentioned (remaining) winding structure consisting of the primary core wire 3 and the wrapping wire 11 forms a receiving and holding framework or a receiving and holding structure for the emitter material 37. FIG. 3B shows, in the right-hand part of the figure, a winding structure 31 provided with emitter material 37 in this way, as is developed from the tertiary winding 31 as explained above, and FIG. 3B shows, in the left-hand part of the figure, a winding structure 21′, 1′ which adjoins the winding structure 31′ shown on the right-hand part of the figure, which winding structure 21′, 1′ is developed from the secondary winding 21 as explained above (sometimes provided with emitter material 37 and sometimes not provided with emitter material 37) with the primary winding 1 thereof.

The (remaining) winding structure provided with the (Ba, Ca, Sr) CO₃ emitter material 37 in this way is then subjected to a thermal treatment in order to convert the (Ba, Ca, Sr) CO₃ material (carbonate material) into (Ba, Ca, Sr) O emitter material 37 (oxide material). The conversion into the oxide is generally only performed when the subsequent lamp is exhausted, but before it is sealed (fused shut). The oxides are hygroscopic. Therefore, they are not resistant to air. The carbonate is applied and only when the lamp has been exhausted and flushed generally at least once, temperature is supplied via a current through the filament and the carbonate is converted into oxide. The resultant CO₂ is exhausted. From this point on, it should not be possible for any air and primarily any moisture to arrive at the filament any more.

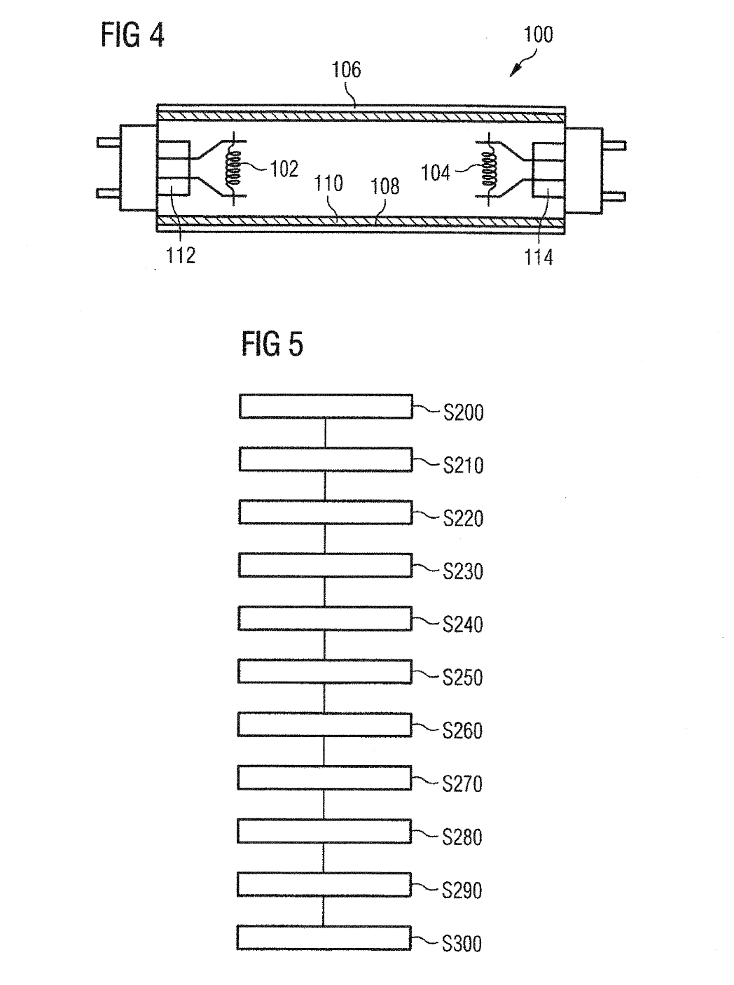

The (remaining) winding structure filled with the emitter material 37 (converted to oxide material) and including the primary core wire 3 and the wrapping wire 11 can be used in a discharge lamp 100 shown in longitudinal section as in FIG. 4, for example, as an electrode 102, wherein the discharge lamp 100 shown in FIG. 4 has two such electrodes 102, 104. Otherwise, the discharge lamp 100 illustrated in FIG. 4 can be constructed, for example, as the discharge lamp described in US 2004/0070324 A1 and can have, for example: a glass envelope 106, whose inner face 108 is coated with a phosphor-containing layer 110 and whose interior is provided with a noble gas (such as argon or neon, for example)/mercury discharge fill. The electrodes 102, 104 are held on bases 112 and 114, respectively, via which the power supply to the electrodes 102, 104 is provided. Instead of the lamp illustrated as in FIG. 4 with bases 112 and 114 at both longitudinal ends, any other lamp shapes are also possible, such as lamps with a base arranged at one end, for example, which have one or more bent tubes attached to one another, for example.

FIG. 5 shows a flowchart of a method according to the disclosure for producing an electrode, such as, for example, the electrode 102 or 104 shown in FIG. 4 for a discharge lamp, such as the discharge lamp 100 shown in FIG. 5, for example.

The method shown in FIG. 5 has the following steps: (S200) providing a primary core wire (such as, for example, the primary core wire 3 in FIGS. 1-3), which has a longitudinal axis and consists of an electrically conductive material, (S210) winding a cladding wire (such as, for example, the cladding wire 7 in FIGS. 1-3) around the primary core wire along the longitudinal axis of the primary core wire, with the result that the cladding wire forms a primary core wire cladding surrounding the primary core wire (such as, for example, the primary core wire cladding 9 in FIGS. 1-3), (S220) helically winding a wrapping wire (such as, for example, the wrapping wire 11 in FIGS. 1-3) around the primary core wire cladding at a radial distance from the primary core wire along the longitudinal axis of the primary core wire, as a result of which a primary winding (such as, for example, the primary winding 1 shown in FIGS. 1-3) is achieved.

The method shown in FIG. 5 also has the following steps: (S230) providing a secondary core wire, such as, for example, the secondary core wire 23 shown in FIGS. 2 and 3, which has a longitudinal axis 25, and (S240) helically winding the primary winding in the longitudinal direction of the primary core wire around the secondary core wire along the longitudinal axis of the secondary core wire, as a result of which a secondary winding (such as, for example, the secondary winding 21 shown in FIGS. 2 and 3), is achieved. Then, the secondary winding can be subjected to a heat treatment (for example annealing treatment) in order to reduce material stresses occurring as a result of the winding operation in the primary core wire and in the wrapping wire.

The method shown in FIG. 5 also has the following steps: (S250) providing a tertiary core (wire), such as, for example, the tertiary core (wire) 33 shown in FIG. 3A, which has a longitudinal axis, and (S260) helically winding the secondary winding in the longitudinal direction of the secondary core wire around the tertiary core (wire) along the longitudinal axis of the tertiary core (wire), as a result of which a tertiary winding (such as, for example, the tertiary winding 31 shown in FIG. 3A) is achieved.

The method shown in FIG. 5 also has the following steps: (S270) removing the cladding wire, the secondary core wire and the tertiary core (wire) from the (remaining) winding structure, which has the primary core wire and the wrapping wire, so as to form corresponding (emitter material) receiving cavities between the primary core wire and the wrapping wire. Prior to the step involving the removal of the cladding wire and the secondary core wire, the tertiary winding can be subjected to a heat treatment (for example annealing treatment) (wherein the reusable tertiary core has generally already been removed or wherein the lost tertiary core wire has generally not yet been removed) in order to reduce material stresses occurring as a result of the winding operation in the primary core wire and in the wrapping wire.

The method shown in FIG. 5 also has the following steps: (S280) introducing an emitter material, such as, for example, the above-explained emitter material 37, into the emitter material receiving cavities and possibly also between the cavities otherwise provided between the primary core wire and the wrapping wire, as a result of which a winding structure is achieved which can be used as electrode. As explained above, the emitter material may still need to be subjected to a further treatment step, for example an activation step. Thus, for example, in the case of the use of the abovementioned (Ba, Ca, Sr) CO₃ emitter material in a step (S290), the winding structure provided with the emitter material is introduced, for example, into a discharge lamp (fluorescent lamp) and then, in a step (S300), is subjected to a heat treatment by a supply of current to the winding structure which is heated thereby in order to activate the emitter material, i.e. in order to convert in this case the carbonate material into an (Ba, Ca, Sr) oxide emitter material. The winding structure with the emitter material activated in this way ultimately forms the electrode, such as the electrode 102 or 104 in the discharge lamp 100 shown in FIG. 4, for example.

While the disclosed embodiments has been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A method for producing an electrode for discharge lamps, comprising:
producing a primary winding, wherein producing the primary winding comprises:
providing a primary core wire, which has a longitudinal axis and consists of an electrically conductive material,
winding a cladding wire around the primary core wire along the longitudinal axis of the primary core wire, with the result that the cladding wire forms a primary core wire cladding surrounding the primary core wire, and
winding a wrapping wire around the primary core wire cladding at a radial distance from the primary core wire along the longitudinal axis of the primary core wire.

2. The method as claimed in claim 1, wherein, during winding of the cladding wire, the turns of the cladding wire are arranged directly adjacent to one another in the direction of the longitudinal axis of the primary core wire.

3. The method as claimed in claim 1, wherein, during winding of the wrapping wire, the turns of the wrapping wire are arranged at an axial distance from one another in the direction of the longitudinal axis of the primary core wire, which axial distance is greater than an axial distance between the turns of the cladding wire in the direction of the longitudinal axis of the primary core wire.

4. The method for producing an electrode for discharge lamps as claimed in claim 1, further comprising:
producing a secondary winding, wherein producing the secondary winding comprises:
providing a secondary core wire which has a longitudinal axis, and
winding the primary winding in the longitudinal direction of the primary core wire around the secondary core wire along the longitudinal axis of the secondary core wire.

5. The method for producing an electrode for discharge lamps as claimed in claim 4, further comprising:
producing a tertiary winding, wherein producing the tertiary winding comprises:
providing a tertiary core which has a longitudinal axis, and
winding the secondary winding in the longitudinal direction of the secondary core wire around the tertiary core along the longitudinal axis of the tertiary core.

6. The method as claimed in claim 4, wherein the cladding wire and the secondary core wire are removed from the remaining winding structure formed by the primary core wire and the wrapping wire, and are separated from the remaining winding structure formed by the primary core wire and the wrapping wire.

7. The method as claimed in claim 5, wherein the cladding wire, the secondary core wire and the tertiary core are removed from the remaining winding structure formed by the primary core wire and the wrapping wire.

8. The method as claimed in claim 1, wherein at least one of the diameter of the primary core wire, the diameter of the cladding wire, the diameter of the wrapping wire, the diameter of the secondary core wire and the diameter of the tertiary core are constant along the length of the respective wire.

9. A primary winding for an electrode for discharge lamps, comprising:
a primary core wire, which has a longitudinal axis and consists of an electrically conductive material,
a cladding wire, which is wound around the primary core wire along the longitudinal axis of the primary core wire, with the result that the cladding wire forms a primary core wire cladding surrounding the primary core wire, and
a wrapping wire, which is wound around the primary core wire cladding at a radial distance from the primary core wire along the longitudinal axis of the primary core wire.

10. The primary winding as claimed in claim 9, wherein the turns of the cladding wire are arranged directly adjacent to one another in the direction of the longitudinal axis of the primary core wire.

11. The primary winding as claimed in claim 9, wherein the turns of the wrapping wire are arranged at an axial distance from one another in the direction of the longitudinal axis of the primary core wire, which axial distance is greater than an axial distance between the turns of the cladding wire in the direction of the longitudinal axis of the primary core wire.

12. A secondary winding for producing an electrode for discharge lamps, comprising:
a secondary core wire, which has a longitudinal axis, and
a primary winding comprising:
a primary core wire, which has a longitudinal axis and consists of an electrically conductive material,
a cladding wire, which is wound around the primary core wire along the longitudinal axis of the primary core wire, with the result that the cladding wire forms a primary core wire cladding surrounding the primary core wire, and
a wrapping wire, which is wound around the primary core wire cladding at a radial distance from the primary core wire along the longitudinal axis of the primary core wire,
wherein the primary winding is wound in a longitudinal direction of the primary core wire around the secondary core wire along the longitudinal axis of the secondary core wire.

13. A tertiary winding for producing an electrode for discharge lamps, comprising:
a tertiary core, which has a longitudinal axis, and
a secondary winding comprising:
a secondary core wire, which has a longitudinal axis, and
a primary winding comprising:
a primary core wire, which has a longitudinal axis and consists of an electrically conductive material,
a cladding wire, which is wound around the primary core wire along the longitudinal axis of the primary core wire, with the result that the cladding wire forms a primary core wire cladding surrounding the primary core wire, and
a wrapping wire, which is wound around the primary core wire cladding at a radial distance from the primary core wire along the longitudinal axis of the primary core wire,
wherein the primary winding is wound in a longitudinal direction of the primary core wire around the secondary core wire along the longitudinal axis of the secondary core wire,
wherein the secondary winding is wound in the longitudinal direction of the secondary core wire around the tertiary core along the longitudinal axis of the tertiary core.

14. A method for producing an electrode for a discharge lamp, comprising:
producing a secondary winding having a secondary core wire, which has a longitudinal axis, and a primary winding comprising:
a primary core wire, which has a longitudinal axis and consists of an electrically conductive material,
a cladding wire, which is wound around the primary core wire along the longitudinal axis of the primary core wire, with the result that the cladding wire forms a primary core wire cladding surrounding the primary core wire, and
a wrapping wire, which is wound around the primary core wire cladding at a radial distance from the primary core wire along the longitudinal axis of the primary core wire,
wherein the primary winding is wound in a longitudinal direction of the primary core wire around the secondary core wire along the longitudinal axis of the secondary core wire,
wherein producing the secondary winding comprises:
providing a secondary core wire which has a longitudinal axis, and winding the primary winding in the longitudinal direction of the primary core wire around the secondary core wire along the longitudinal axis of the secondary core wire,
removing the secondary core wire and the cladding wire so as to form corresponding emitter material receiving cavities in what is left of the remaining winding structure formed by the primary core wire and the wrapping wire, and
introducing an emitter material into the emitter material receiving cavities.

15. A method for producing an electrode for a discharge lamp, comprising:
producing a tertiary winding having a tertiary core, which has a longitudinal axis, and a secondary winding comprising:
a secondary core wire, which has a longitudinal axis, and a primary winding comprising:
a primary core wire, which has a longitudinal axis and consists of an electrically conductive material,
a cladding wire, which is wound around the primary core wire along the longitudinal axis of the primary core wire, with the result that the cladding wire forms a primary core wire cladding surrounding the primary core wire, and
a wrapping wire, which is wound around the primary core wire cladding at a radial distance from the primary core wire along the longitudinal axis of the primary core wire,
wherein the primary winding is wound in a longitudinal direction of the primary core wire around the secondary core wire along the longitudinal axis of the secondary core wire,
wherein the secondary winding is wound in the longitudinal direction of the secondary core wire around the tertiary core along the longitudinal axis of the tertiary core,
wherein producing the tertiary winding comprises:
providing a tertiary has a longitudinal axis, and winding the secondary winding in the longitudinal direction of the secondary core wire around the tertiary core along the longitudinal axis of the tertiary core,
removing the secondary core wire, the tertiary core and the cladding wire so as to form corresponding emitter material receiving cavities in what is left of the remaining winding structure formed by the primary core wire and the wrapping wire, and
introducing an emitter material into the emitter material receiving cavities.

16. The method as claimed in claim 4, wherein the cladding wire and the secondary core wire are dissolved by means of a solvent.
